(19) United States
(12) Patent Application Publication
(10) Pub. No.: US 2026/0192804 A1
(43) Pub. Date: Jul. 9, 2026

(54) SINGLE LANE ROAD PASSING ASSISTANCE

(71) Applicant: GM GLOBAL TECHNOLOGY OPERATIONS LLC, Detroit, MI (US)

(72) Inventors: Mohammad Naserian, Rochester Hills, MI (US); Akilesh Rajavenkatanarayanan, Clinton Township, MI (US); Manoj Kumar Sharma, Troy, MI (US); Apral S. Hara, Lasalle (CA)

(73) Assignee: GM GLOBAL TECHNOLOGY OPERATIONS LLC, Detroit, MI (US)

(21) Appl. No.: 19/013,004

(22) Filed: Jan. 8, 2025

(51) Int. Cl. B60W 30/18; B60W 10/18; B60W 10/20; B60W 50/14; B60W 60/00

(52) U.S. Cl. CPC B60W 30/18163; B60W 10/18; B60W 10/20; B60W 50/14; B60W 60/001; B60W 2050/146

(57) ABSTRACT

Methods and systems are provided that provide single lane passing assistance for vehicles. Sensors are configured to obtain sensor data as to a second vehicle that is travelling in the same lane as the vehicle with a lower rate of speed. The processor is coupled to the sensors and to one or more remote devices, and is configured to at least facilitate receiving the sensor data from the sensors; receiving additional data from the one or more remote devices as to the roadway, including oncoming traffic in an adjacent lane; determining, using the sensor data and the additional data, a passing maneuver for the vehicle to overtake the second vehicle and a level of caution associated with the passing maneuver; and performing a vehicle control action, via instructions provided by the processor, based on the passing maneuver and the level of caution associated therewith.

### TECHNICAL FIELD

The technical field generally relates to vehicles and, more specifically, to methods and systems for providing passing assistance for drivers of vehicles.

### BACKGROUND

Drivers of vehicles today may encounter situations in which the vehicle is travelling behind a slower vehicle in a single lane of traffic, and in which assistance may be desired for passing the slower vehicle.

Accordingly, it is desirable to provide methods and systems for providing passing assistance for vehicles, including in a single lane of traffic.

### SUMMARY

In accordance with an exemplary embodiment, a method is provided that includes obtaining sensor data via one or more sensors of a vehicle that is travelling in a lane along a single lane roadway having a single lane in each direction, as to a second vehicle that is travelling in the same lane as the vehicle with a lower rate of speed as compared with the vehicle; obtaining additional data as to the roadway, including oncoming traffic in an adjacent lane that is adjacent to the lane of the vehicle; determining, via a processor of the vehicle using the sensor data and the additional data: a passing maneuver for the vehicle to overtake the second vehicle; and a level of caution associated with the passing maneuver; and performing a vehicle control action, via instructions provided by the processor, based on the passing maneuver and the level of caution associated therewith.

Also in an exemplary embodiment, the additional data is further obtained from vehicle to vehicle communications and also includes map data as to features of the roadway, including whether a passing lane is present along the roadway in proximity to the vehicle, in addition to the oncoming traffic.

Also in an exemplary embodiment, the additional data is further obtained from vehicle to infrastructure communications and also includes map data as to features of the roadway, including whether a passing lane is present along the roadway in proximity to the vehicle, in addition to the oncoming traffic.

Also in an exemplary embodiment, the performing of the vehicle control action comprises providing a visual notification to a driver of the vehicle, on a display screen of the vehicle in accordance with instructions provided by the processor, with the level of caution, along with an indication as to whether or not it would be advisable to proceed with the passing maneuver.

Also in an exemplary embodiment, the performing of the vehicle control action further comprises controlling movement of the vehicle, in accordance with instructions provided by the processor and that are executed by one or more of a braking system, a steering system, and a drive system of the vehicle.

Also in an exemplary embodiment, the level of caution is determined via the processor based on a relative distance between the vehicle and the second vehicle, a relative distance between the vehicle and an oncoming vehicle of the oncoming traffic, and velocities and accelerations of each of the vehicle, the second vehicle, and the oncoming vehicle.

Also in an exemplary embodiment, the level of caution is determined via the processor based also on whether a passing lane is present along the roadway.

Also in an exemplary embodiment, the level of caution is determined via the processor in accordance with the following equation: (C)=(TTT)−(O)−(F)−(L), in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic.

Also in an exemplary embodiment, if it is determined that the clearance time is greater than or equal to a first threshold, then the passing maneuver is categorized into a low risk level; if it is instead determined that the clearance time is less than or equal to the first threshold as well as less than or equal to a second threshold that is less than the first threshold, then the passing maneuver is categorized instead into a high risk level; and if it is instead determined that the clearance time is less than or equal to the first threshold but greater than the second threshold, then the passing maneuver is categorized instead into a medium risk level.

In another exemplary embodiment, a system is provided that includes one or more sensors of a vehicle and a processor of the vehicle. The one or more sensors are configured to obtain, as the vehicle that is travelling in a lane along a single lane roadway having a single lane in each direction, sensor data as to a second vehicle that is travelling in the same lane as the vehicle with a lower rate of speed as compared with the vehicle. The processor is coupled to the one or more sensors and to one or more remote devices, and that is configured to at least facilitate receiving the sensor data from the one or more sensors; receiving additional data from the one or more remote devices as to the roadway, including oncoming traffic in an adjacent lane that is adjacent to the lane of the vehicle; determining, using the sensor data and the additional data: a passing maneuver for the vehicle to overtake the second vehicle; and a level of caution associated with the passing maneuver; and performing a vehicle control action, via instructions provided by the processor, based on the passing maneuver and the level of caution associated therewith.

Also in an exemplary embodiment, the additional data is further obtained from vehicle to vehicle communications and also includes map data as to features of the roadway, including whether a passing lane is present along the roadway in proximity to the vehicle, in addition to the oncoming traffic.

Also in an exemplary embodiment, the additional data is further obtained from vehicle to infrastructure communications and also includes map data as to features of the roadway, including whether a passing lane is present along the roadway in proximity to the vehicle, in addition to the oncoming traffic.

Also in an exemplary embodiment, the processor is further configured to at least facilitate performing the vehicle control action by providing a visual notification to a driver of the vehicle, on a display screen of the vehicle in accordance with instructions provided by the processor, with the level of caution, along with an indication as to whether or not it would be advisable to proceed with the passing maneuver.

Also in an exemplary embodiment, the processor is further configured to at least facilitate performing the vehicle control action by providing a haptic notification to the driver of the vehicle.

Also in an exemplary embodiment, the processor is further configured to at least facilitate performing the vehicle control action by controlling movement of the vehicle, in accordance with instructions provided by the processor and that are executed by one or more of a braking system, a steering system, and a drive system of the vehicle.

Also in an exemplary embodiment, the processor is further configured to at least facilitate determining the level of caution based on a relative distance between the vehicle and the second vehicle, a relative distance between the vehicle and an oncoming vehicle of the oncoming traffic, and velocities and accelerations of each of the vehicle, the second vehicle, and the oncoming vehicle, and further based on whether a passing lane is present along the roadway.

Also in an exemplary embodiment, the processor is further configured to at least facilitate determining the level of caution in accordance with the following equation: (C)=(TTT)−(O)−(F)−(L), in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic.

Also in an exemplary embodiment, the processor is further configured to at least facilitate categorizing the passing maneuver into: a low risk level, if it is determined that the clearance time is greater than or equal to a first threshold; a high risk level, if it is instead determined that the clearance time is less than or equal to the first threshold as well as less than or equal to a second threshold that is less than the first threshold; and a medium risk level, if it is instead determined that the clearance time is less than or equal to the first threshold but greater than the second threshold.

In another exemplary embodiment, a vehicle is provided that includes a body, a drive system, a display system, one or more sensors, a transceiver, and a processor. The drive system is configured to move the body. The display system has a display screen. The one or more sensors are configured to obtain, as the vehicle is travelling along a roadway in a lane of a single lane highway having a single lane in each direction, sensor data as to a second vehicle that is travelling in the same lane as the vehicle with a lower rate of speed as compared with the vehicle. The transceiver is configured to receive additional data from one or more remote devices as to the roadway via vehicle to vehicle communications, vehicle to infrastructure communications, or both. The additional data comprises whether a passing lane is present along the roadway in proximity to the vehicle, in addition to oncoming traffic, as the vehicle is travelling along the single lane highway. The processor is coupled to the one or more sensors and to the transceiver, and is configured to at least facilitate, as the vehicle is travelling along the single lane highway: determining, using the sensor data and the additional data, a passing maneuver for the vehicle to overtake the second vehicle; a level of caution associated with the passing maneuver determining the level of caution in accordance with the following equation: (C)=(TTT)−(O)−(F)−(L), in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic, and including by categorizing the passing maneuver into: a low risk level, if it is determined that the clearance time is greater than or equal to a first threshold; a high risk level, if it is instead determined that the clearance time is less than or equal to the first threshold as well as less than or equal to a second threshold that is less than the first threshold; and a medium risk level, if it is instead determined that the clearance time is less than or equal to the first threshold but greater than the second threshold; and performing a vehicle control action, via instructions provided by the processor, based on the passing maneuver and the level of caution associated therewith, including by providing a visual notification to a driver of the vehicle, on the display screen of the vehicle in accordance with instructions provided by the processor, with the level of caution, along with an indication as to whether or not it would be advisable to proceed with the passing maneuver.

In another exemplary embodiment, the vehicle further includes a braking system; and a steering system; wherein the processor is further configured to at least facilitate performing the vehicle control action by controlling movement of the vehicle, in accordance with instructions provided by the processor and that are executed by one or more of the braking system, the steering system, and the drive system of the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle and a remote device, the vehicle having a control system for providing passing assistance for vehicles, including in a single lane of traffic, in accordance with exemplary embodiments;

FIG. 2 is a flowchart for a process for providing passing assistance for vehicles, including in a single lane of traffic, and that can be implemented in connection with the system of FIG. 1, including the remote device and the vehicle and control system thereof, in accordance with exemplary embodiments; and

FIG. 3 depicts an exemplary implementation of a step of the process of FIG. 2, namely, the step of calculating a risk factor for a passing maneuver in a single lane of traffic, in accordance with exemplary embodiments;

FIG. 4 depicts an exemplary implementation of real-time connectivity for the process of FIG. 2, including the step of FIG. 3, in accordance with exemplary embodiments; and

FIGS. 5-8 depict exemplary implementations of displays provided via the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

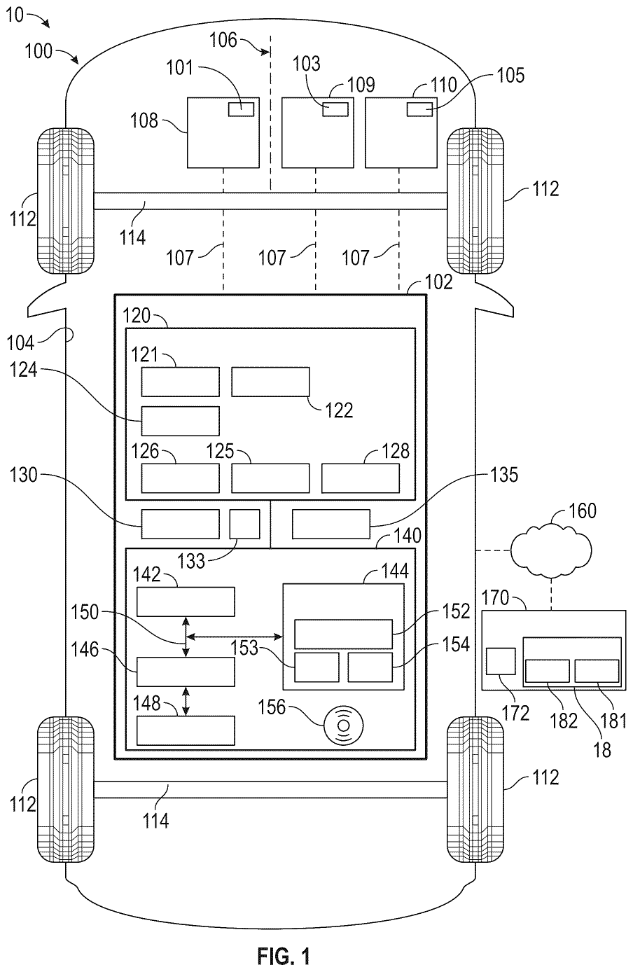

FIG. 1 illustrates a system 10 that includes a vehicle 100 and a remote device 170. As illustrated in FIG. 1, the system 10 further includes one or more wireless communication networks 160 that communicatively couple together the vehicle 100 and the remote device 170. In certain embodiments, the vehicle 100 is representative of a number of different vehicles (e.g., in a fleet) that are likewise coupled to the remote device 170 via the wireless communication networks 160, and that have similar features as those depicted in FIG. 1 and described below in connection with the vehicle 100. Also in various embodiments, the remote device 170 is representative of one or more other vehicles (e.g., for vehicle to vehicle communications), remote servers, and/or infrastructure (e.g., traffic lights, signs, road apparatus, or the like for vehicle to infrastructure communications).

In various embodiments, and as described below, the vehicle 100 includes a control system 102 for controlling various functions of the vehicle 100, including for providing passing assistance for vehicles, including in a single lane of traffic.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In certain embodiments, the vehicle 100 may comprise an autonomous or semi-autonomous vehicle, for example in which vehicle control (including propulsion, steering, braking, and the like) is automatically planned and executed by the control system 102, in whole or in part. In certain other embodiments, the vehicle 100 may also be operated in whole or in part by a human driver.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain embodiments, the drive system 110 provides propulsion in accordance with a driver intent as manifested via the driver's engagement of an accelerator pedal. Also in certain embodiments, the drive system 110 may also provide automatic propulsion control in appropriate circumstances in accordance with instructions provided by the control system 102.

In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the vehicle 100 also includes a braking system 108 and a steering system 109 in various embodiments. In exemplary embodiments, the braking system 108 controls braking of the vehicle 100 using braking components that are controlled via inputs provided by a driver (e.g., via a braking pedal 101 in certain embodiments) and/or automatically via the control system 102 in appropriate circumstances.

Also in exemplary embodiments, the steering system 109 controls steering of the vehicle 100 via steering components (e.g., a steering column coupled to the axles 114 and/or the wheels 112) that are controlled via inputs provided by a driver (e.g., via a steering wheel 103 in certain embodiments) and/or automatically via the control system 102 in appropriate circumstances.

In the embodiment depicted in FIG. 1, the control system 102 is coupled to the braking system 108, the steering system 109, and the drive system 110, as well as to the remote device 170. As noted above, in certain embodiments, the vehicle 100 includes one or more functions controlled automatically via the control system 102, including for providing passing assistance for vehicles, including in a single lane of traffic.

As depicted in FIG. 1, in various embodiments, the control system 102 includes a sensor array 120, a location system 130, a transceiver 133, a display system 135, and a controller 140.

In various embodiments, the sensor array 120 includes various sensors that obtain sensor data pertaining to operation of the vehicle 100 as well as to a roadway in which the vehicle 100 is travelling and other vehicles on the roadway. In the depicted embodiment, the sensor array 120 includes one or more radar sensors 121, cameras 122, and/or Lidar sensors 124. In various embodiments, the sensor array 120 includes one or more velocity sensors 125, accelerometers 126, and/or other sensors 128.

In various embodiments, the radar sensors 121, cameras 122, and/or Lidar sensors 124 obtain detection sensor data outside the vehicle 100. In various embodiments, the detection sensor data relates to detected other vehicles along the roadway in which the vehicle 100 is travelling.

Also in various embodiments, the velocity sensors 125 obtain speed sensor data (or velocity sensor data) as to a speed or velocity of the vehicle 100. In certain embodiments, the velocity sensors 125 comprise one or more wheel speed sensors that are coupled to one or more of the wheels 112 of the vehicle 100.

Also in various embodiments, the accelerometers 127 obtain acceleration data as to an acceleration data of the vehicle 100.

In various embodiments, the sensor array 120 may also include one or more other sensors 128 such as, by way of example, one or more transmission and/or gear sensors of the vehicle 100 (e.g., as to whether the engine is turned on, and/or a current gear of the vehicle 100, and so on), one or more other detection sensors for detecting other vehicles or objects on the roadway in which the vehicle 100 is travelling (e.g., one or more sonar sensors or the like), one or more input sensors (e.g., for the driver to approve or initiate a passing maneuver to overtake a slower vehicle in the same lane), and/or one or more other types of sensors.

Also in various embodiments, the location system 130 is configured to obtain and/or generate data as to a position and/or location in which the vehicle 100 is travelling and/or is about to park. In certain embodiments, the location system 130 comprises and/or or is coupled to a satellite-based network and/or system, such as a global positioning system (GPS) and/or other satellite-based system, and/or using a transmission control protocol (TCP) or the like.

In certain embodiments, the vehicle 100 also includes a transceiver 133. In various embodiments, the transceiver 133 communicates with the remote devices 170 via the one or more wireless communication networks 160.

In various embodiments, the display system 135 provides information or instructions for a driver and/or other occupants of the vehicle 100. In certain embodiments, the display system 135 provides, among other possible information, instructions or recommendations for the driver pertaining to assistance for vehicles, including in a single lane of traffic. In certain embodiments, the display system 135 may provide a visual description on a display screen pertaining to the assistive control actions. In certain other embodiments, one or more audio, haptic, and/or other notifications may also be provided. Also in certain embodiments, the display system 135 may also include, in addition to a display screen, an infotainment system, a head-up-display, a windshield display, and augmented display, or the like, among other possible features and components.

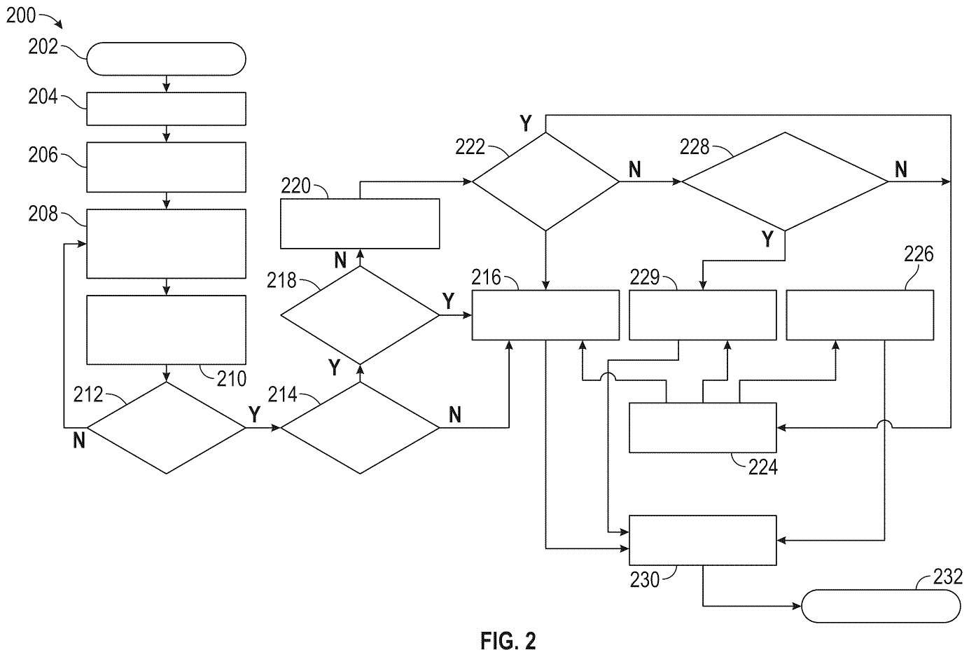

In various embodiments, the controller 140 is coupled to the sensor array 120, the location system 130, the transceiver 133, and the display system 135, and in various embodiments also to the remote devices 170. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 performs assistance for vehicles, including in a single lane of traffic based on the sensor data obtained from the sensor array 120, and in certain embodiments from the location data obtained from the location system 130 (and, also in various embodiments, also from data obtained via the transceiver 133 from the remote devices 170). In various embodiments, the controller 140 provides these and other functions in accordance with the steps of the processes and implementations depicted in FIGS. 2-8 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote device, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the processes and implementations depicted in FIGS. 2-8 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 153 (e.g., from and/or used in connection with the location system 130 and/or transceiver 133) and one or more stored values 154 (e.g., including, in various embodiments, threshold values).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, the location system 130, and/or the remote devices 170. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 2-8 and as described further below in connection therewith. In another exemplary embodiment, the program product may be directly stored in and/or otherwise accessed by the memory 144 and/or a disk (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, as depicted in FIG. 1 and as described above, in various embodiments the remote device 170 is coupled to the vehicle 100 via the one or more wireless communication networks 160. Similar to the discussion above, in various embodiments, the remote device 170 depicted in FIG. 1 may be representative of one or more different remote devices 170 that comprise and/or are part of and/or coupled to one or more other vehicles (e.g., for vehicle to vehicle communications), remote servers, and/or infrastructure (e.g., traffic lights, signs, road apparatus, or the like for vehicle to infrastructure communications).

In various embodiments, the remote device 170 provides sensor data and/or other information as to the roadway on which the vehicle 100 is travelling, along with other vehicles and other objects on the roadway.

In various embodiments, the remote device 170 provides these functions utilizing, among other components, a transceiver 172 and a computer system 180 including a processor 182 and memory 184, and with features similar to those described above in connection with the vehicle 100 (e.g. vehicle 100's transceiver 133, controller/computer system 140, processor 142, memory 144, and so on).

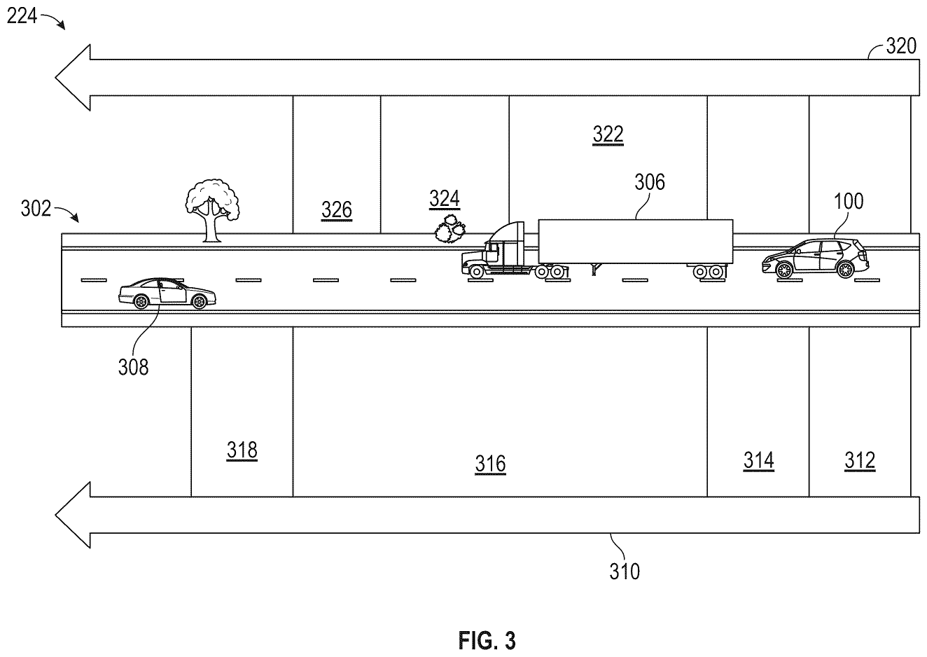

With reference to FIG. 2, a flowchart is provided of a process 200 for providing passing assistance for vehicles, including in a single lane of traffic, in accordance with exemplary embodiments. In various embodiments, the process 200 can be implemented in connection with the system 10 of FIG. 1, including the vehicle 100 (including the control system 102 thereof), the remote device 170, and other components thereof. Also in various embodiments, the process 200 can also be implemented in connection with the various implementations thereof as depicted in FIGS. 3-8 and as described further below in connection therewith.

As depicted in FIG. 2, the process 200 begins in certain embodiments when the vehicle 100 is turned on and/or begins operation (e.g., in a current vehicle drive). In one embodiment, the steps of the process 200 are performed continuously during operation of the vehicle.

In various embodiments, data is obtained (step 202). In various embodiments, sensor data, location data, and map data are obtained. Specifically, in various embodiments, sensor data is obtained from the sensor array 120 of FIG. 1 regarding the roadway, detected other vehicles on the roadway (i.e., from the radar sensors 121, cameras 122, and/or Lidar sensors 124 of FIG. 1), and regarding operation of the vehicle 100 (i.e., from the velocity sensors 125 and/or accelerometers 126 of FIG. 1), along with location data from the location system 130 of FIG. 1 as to the location of the vehicle 100 and additional sensor data from the remote device 170 as to the roadway and other vehicles on the roadway. Also in various embodiments, map data as to the roadway is also obtained via the memory 144 of the vehicle 100 and/or from the remote device 170.

In various embodiments, a determination is made that the vehicle 100 is travelling on a roadway with a single lane (step 206). Specifically, in various embodiments, during step 206, a determination is made by the processor 142 based on the data of step 204 that the vehicle 100 is travelling along a roadway with only a single lane of travel in the same direction as movement of the vehicle 100, such that the vehicle 100 would need to turn into an opposing lane of travel in order to pass another vehicle that is travelling in the same current lane as the vehicle 100.

In various embodiments, as the vehicle 100 is travelling in the single lane, another vehicle is detected (step 208). Specifically, in various embodiments, one or more detection sensors (such as the radar sensors 121, cameras 122, and/or Lidar sensors 124 of FIG. 1) detect a slower moving other vehicle that is travelling in the same lane as the vehicle but at a slower speed than the vehicle 100. In various embodiments, the slower vehicle is travelling at a speed that is less than a posted legal speed limit with a difference that is at least is great as a predetermined threshold value (i.e., that is stored in the memory 144 as a stored value 154 thereof in certain embodiments).

In various embodiments, a request is made for a passing maneuver (step 210). Specifically, in various embodiments, the processor 142 of FIG. 1 provides instructions for the display system 135 to provide a recommendation (e.g., via a visual display on a display screen) for the driver for the driver to initiate or approve a passing maneuver to overtake the slower vehicle.

In various embodiments, a determination is made as to whether the driver has approved the request (step 212). Specifically, in various embodiments, the processor 142 determines whether the driver has approved the request from step 210 to initiate or approve a passing maneuver to overtake the vehicle 100 (e.g., via one or more input sensors, such as of the other sensors 128 of FIG. 1 in certain embodiments).

In various embodiments, if it is determined in step 212 that the driver has not approved the request for the passing maneuver, then the process returns to step 208. In various embodiments, steps 208-212 continue in various iterations until it is determined in an iteration of step 212 that the driver has approved the request for the passing maneuver.

Conversely, in various embodiments, once it is determined in an iteration of step 212 that the driver has approved the request for the passing maneuver, a determination is made as to whether it is legal to execute the passing maneuver (step 214). Specifically, in various embodiments, during step 214 the processor 142 determines whether it would be legal to pass the slower moving vehicle in the same lane of travel, given the current roadway and applicable laws and regulations. Specifically, in various embodiments, lane markings and/or information is ascertained regarding the lane and roadway from camera data (e.g., from the cameras 122), map data (e.g., the map data 153 of the memory 144 of FIG. 1), or the like to determine the legality of the potential passing maneuver. For example, in various embodiments, a dashed lane marking may indicate that passing is allowed, whereas a solid lane marking may indicate that passing is not allowed, and so on.

In various embodiments, if it is determined in step 214 that the passing maneuver is not legal, then the process proceeds to step 216. In various embodiments, during step 216 a high level of caution is exercised, and a determination is made by the processor 142 that the passing maneuver is not appropriate. Also in certain embodiments, a notification is provided by the display system 135 of FIG. 1, in accordance with instructions provided by the processor 142, that passing is not appropriate. In certain embodiments, a visual notice is provided. In certain embodiments, one or more other notices may also be provided (e.g., audio and/or haptic). Also in various embodiments, the notice includes the reason why passing is not appropriate (e.g., in this example, due to the illegality of the passing maneuver as reflected via the lane markings).

In various embodiments, one or more other vehicle actions may also be taken (step 230). Specifically, in certain embodiments, when the passing maneuver has already begun and it is subsequently determined that completing the passing maneuver may not be advisable (e.g., due to a change in speed or acceleration of the vehicle 100 and/or one or more other vehicles, and/or one or more other circumstances), the processor 142 may provide instructions for a display (e.g., via the display system 135) for the driver to abort the passing maneuver and instead return to the original lane of travel (e.g., pulling back behind the slower moving vehicle). Also in certain embodiments if the driver has selected an automated assist feature, the processor 142 may provide instructions to the braking system 108, steering system 109, and/or drive system 110 that execute the instructions to automatically control movement of the vehicle 100 in whole or in part, including for executing and/or aborting the passing maneuver as determined by the processor 142 and/or for providing resistance (e.g., to steering) as a warning to the driver, and so on. In various embodiments, the process then terminates at 232.

With reference back to step 214, in various embodiments, if it is instead determined in step 214 that the passing maneuver is legal, then the process proceeds instead to step 218. In various embodiments, during step 218, a determination is made by the processor 142 as to whether a passing lane is nearby. Specifically, in various embodiments, during step 218 the processor 142 determines whether a passing lane is upcoming along the roadway in the current direction of travel of the vehicle 100, such that the vehicle 100 can use the passing lane to pass and overtake the slower moving vehicle. Specifically, in various embodiments, the determination of whether a passing lane is nearby is made by the processor 142 based on the map data as to whether a passing lane is present within a predetermined distance of the vehicle 100 (e.g., within approximately two to five miles in certain embodiments, although this may vary in other embodiments).

In various embodiments, if it is determined in step 218 that a passing lane is near, then the process proceeds to the above-referenced step 216. As noted above, in various embodiments, a determination is made during step 216 by the processor 142 that the passing maneuver is not appropriate. Also in certain embodiments, a notification is provided by the display system 135 of FIG. 1 (which could include by way of example a display screen, an infotainment system, a head-up-display, a windshield display, and augmented display, or the like), in accordance with instructions provided by the processor 142, that passing is appropriate. In certain embodiments, a visual notice is provided. In certain embodiments, one or more other notices may also be provided (e.g., audio and/or haptic). Also in various embodiments, the notice includes the reason why passing is not appropriate (e.g., in this example, due to the presence of a passing lane within a few mile that can instead and more easily be utilized for passing the slower moving vehicle).

In various embodiments, the process also then proceeds to the above-referenced step 230, in which one or more other vehicle actions may also be taken. Specifically, in the example discussed above in which passing would not be appropriate due to the upcoming passing lane. Also in certain embodiments in which the driver has selected a feature for automated assistance, the processor 142 may also automatically control braking, steering, and/or propulsion (e.g., via the braking system 108, steering system 109, and/or drive system 110) in whole or in part, similar to the discussion above. In various embodiments, the process then terminates at 232.

With reference back to step 218, in various embodiments, if it is instead determined in step 218 that a passing lane is not upcoming, then the process proceeds instead to step 220. In various embodiments, during step 220, an evaluation is performed by the processor 142 as to whether the passing maneuver can be executed safely. Specifically, in various embodiments, during step 220 the processor 142 evaluates whether the passing maneuver can be successfully completed by the host vehicle 100 in passing the slowly moving vehicle using an adjacent lane, and then returning back into the current lane without contacting an oncoming vehicle from the adjacent lane (and further by leaving enough of a caution so as not to cause any concern and/or worry, and so on). In various embodiments, this determination is made by the processor 142 using data pertaining to vehicles that comprise oncoming traffic in the adjacent lane, such as using sensor data from the radar sensors 121, cameras 122, and/or Lidar sensors 124 of FIG. 1, and/or via data obtained from one or more remote devices 170 of FIG. 1 (e.g., via a remote server, and/or via vehicle to vehicle communications or vehicle to infrastructure communications, or the like).

In various embodiments, a determination is made as to whether a detected oncoming vehicle would likely pose a hazard for the passing maneuver (step 222). Specifically, in various embodiments, during step 222, the processor 142 of FIG. 1 determines, based on the evaluation of step 220, whether an oncoming vehicle (e.g., in the adjacent lane) is present such that it would likely impact the passing maneuver.

In various embodiments, if it is determined in step 222 that the detected oncoming vehicle would likely pose a hazard to the passing maneuver, then the process proceeds to the above-referenced step 216. As noted above, in various embodiments, a determination is made during step 216 by the processor 142 with a risk level (e.g., high risk, medium, low risk, as appropriate) regarding the passing maneuver. Also in certain embodiments, a notification is provided by the display system 135 of FIG. 11 (which, as described above, could include by way of example a display screen, an infotainment system, a head-up-display, a windshield display, and augmented display, or the like), in accordance with instructions provided by the processor 142, that passing is appropriate. In certain embodiments, a visual notice is provided. In certain embodiments, one or more other notices may also be provided (e.g., audio and/or haptic). Also in various embodiments, the notice includes the reason why passing is not appropriate (e.g., in this example, due to the proximity of the oncoming traffic).

In various embodiments, the process also then proceeds to the above-referenced step 230, in which one or more other vehicle actions may also be taken. Specifically, in the example discussed above in which passing would not be appropriate due to the upcoming passing lane. Also in certain embodiments, if the driver has selected an automatic assist feature, the processor 142 may also automatically control braking, steering, and/or propulsion in whole or in part similar to the discussion above. In various embodiments, the process then terminates at 232.

In various embodiments, if it is instead determined in step 222 that the detected oncoming vehicle would not likely pose a hazard to the passing maneuver, then the process proceeds instead to step 228.

In various embodiments, during step 228, a determination is made as to whether the data as to oncoming traffic is compromised. Specifically, in various embodiments, during step 228 the processor 142 determines whether the data as to the oncoming traffic, either from (A) the sensor data from the sensor array 120 (such as the radar sensors 121, cameras, and/or Lidar sensors 124 of the vehicle 100) and/or from the remote device 170 (such as via vehicle to vehicle communications and/or vehicle to infrastructure communications) is unavailable and/or occluded.

In various embodiments, if it is determined in step 228 that the data as to the oncoming traffic is compromised, then the process proceeds to step 229. In various embodiments, during step 229 a medium level of caution is exercised, and a determination is made during step 228 by the processor 142 that the passing maneuver should be performed with caution. Also in certain embodiments, a notification is provided by the display system 135 of FIG. 1, in accordance with instructions provided by the processor 142, that passing should proceed with caution. In certain embodiments, a visual notice is provided. In certain embodiments, one or more other notices may also be provided (e.g., audio and/or haptic). Also in various embodiments, the notice includes the reason why the passing maneuver should be performed with caution (e.g., due to the compromised nature of the data).

In various embodiments, the process also then proceeds to the above-referenced step 230, in which one or more other vehicle actions may also be taken. Specifically, in the example discussed above in which the passing maneuver should be performed with caution, in certain embodiments if the driver has selected an automated control feature, then the processor 142 may automatically control braking, steering, and/or propulsion (e.g., via the braking system 108, steering system 109, and/or drive system 110) in whole or in part in a manner that allows for the passing maneuver to be performed, but only using more cautious actions (e.g., via slower speeds and/or other actions of caution). In various embodiments, the process then terminates at 232.

With reference back to step 228, if it is determined instead in step 228 that the data as to the oncoming traffic is not compromised, then the process proceeds instead to step 224. In various embodiments, during step 224, a risk assessment is performed by calculating a risk factor for the passing maneuver in the single lane of traffic. Specifically, in various embodiments, the processor 142 calculates the risk assessment with respect to the oncoming traffic utilizing all of the available data (e.g., including sensor data as well as data from vehicle to vehicle communications and vehicle to infrastructure communications, and so on). In various embodiments, based on the distances between the vehicle 100 and the oncoming traffic, and based also on the operating parameters (e.g., velocity and acceleration) of the vehicle 100 and the oncoming traffic, an assessment is made as to a likelihood that the oncoming traffic would interfere with the vehicle 100's execution of the passing maneuver (or, whether the vehicle 100 would have sufficient room to complete the passing maneuver without interference by or contact with vehicles of the oncoming traffic).

In various embodiments, during step 224, if the oncoming traffic is deemed sufficiently likely to interfere with the passing action such as to justify the high level of caution of step 216, then the proceed proceeds to the above-referenced step 216 with the high caution warning of step 216, followed by the iteration of step 230 of the vehicle action corresponding to the high caution warning of step 216, and so on. In various embodiments, the process 200 then terminates at step 232.

Also in various embodiments, if it is instead determined during step 224 that the oncoming traffic could potentially interfere with the passing action with a lesser probability than the high level of caution of step 216, but instead with a level of caution corresponding to the medium level of caution of step 229, then the proceed proceeds instead to the above-referenced step 229 with the medium caution warning of step 219, followed by the iteration of step 230 of the vehicle action corresponding to the medium caution warning of step 219, and so on. In various embodiments, the process 200 then terminates at step 232.

In addition, in various embodiments, if it is instead determined during step 224 that the oncoming traffic could potentially interfere with the passing action with a still lesser probability than the medium level of caution of step 229, but instead with a low level of caution (such that the oncoming traffic is determined to not pose a risk to the passing maneuver), then the proceed proceeds instead to step 226.

In various embodiments, during step 226, a low level of caution is exercised, and a determination is made by the processor 142 that the passing maneuver is appropriate. Also in certain embodiments, a notification is provided by the display system 135 of FIG. 1, in accordance with instructions provided by the processor 142, that passing is appropriate. In certain embodiments, a visual notice is provided. In certain embodiments, one or more other notices may also be provided (e.g., audio and/or haptic). Also in various embodiments, the notice includes the reason why passing is appropriate (e.g., in this example, due to the illegality of the passing maneuver as reflected via the lane markings).

In various embodiments, one or more other vehicle actions may also be taken (step 230). Specifically, in the example discussed above in which passing is appropriate, in certain embodiments during step 230 if the driver has selected an automated assistance feature then the processor 142 may automatically control braking, steering, and/or propulsion in whole or in part (e.g., via the braking system 108, steering system 109, and/or drive system 110) in a manner that performs, and/or allows the driver to freely perform, the passing maneuver. In various embodiments, the process then terminates at 232.

FIGS. 3-8 provide exemplary implementations of the process 200 of FIG. 2, in accordance with exemplary embodiments.

With reference first to FIG. 3, a flow diagram is provided as to an exemplary implementation of a step of the process of FIG. 2, namely, the step of calculating a risk factor for a passing maneuver in a single lane of traffic (step of FIG. 2), in accordance with exemplary embodiments.

As depicted in FIG. 3, the vehicle 100 is travelling along a roadway 302 with a single lane of traffic in each of two directions. Specifically, the vehicle 100 is travelling in a first lane 303, which is adjacent to a second lane 304 in which vehicles are travelling in an opposite direction. Also as depicted in FIG. 1, a slower moving vehicle 306 is also travelling in the first lane 303 ahead of the vehicle 100, and an oncoming vehicle 318 of oncoming traffic is travelling in the second lane 304.

In various embodiments, similar to the discuss above with respect to FIG. 2, the level of caution for the proposed passing maneuver is determined via the processor 142 based on a relative distance between the vehicle and the second vehicle, a relative distance between the vehicle and an oncoming vehicle of the oncoming traffic, and velocities and accelerations of each of the first vehicle, the second vehicle, and the oncoming vehicle, in addition to whether passing lanes are upcoming along the roadway in which the vehicle 100 is travelling.

Further, as depicted in FIG. 3, additional parameters are utilized in various embodiments. For example, as shown in FIG. 3, in an exemplary embodiment the slower moving vehicle 306 has a length 322. In addition, a minimum overtake gap 324 is determined for overtaking the slower moving vehicle 306, in addition, to a required space after overtake 326 (e.g., to provide a buffer or cushion in passing the slower moving vehicle 306 without causing any contact or fear of contact between the vehicle 100 and the slower moving vehicle 306, and so on). In certain embodiments, a distance (D) 320 between the vehicle 100 and the oncoming vehicle 308 is determined based on a sum of the length 322, minimum overtake gap 324, and required space after overtake 326 added together.

Also as depicted in FIG. 3, in various embodiments the risk factor is calculated using various different parameters. A time to lane change (L) 312 is determined as an amount of time that is required for the vehicle 100 to move into the second lane 304. In addition, a follow-time gap (F) 314 is utilized for the vehicle 100 in following the slower moving vehicle 306. Further, a time to overtake (O) 316 represents an amount of time that is required for the vehicle 100 to reach a point in which the vehicle 100 can safely return to the first lane 303 after passing the slower moving vehicle 306 (i.e., after passing the slower moving vehicle 306 as well as travelling pass the minimum overtake gap 324 and the required space after overtake 326). As depicted in FIG. 3, in an exemplary embodiment a time to target (TTT) 310, calculated in seconds, is equal to the summation of each of the time to lane change (L) 312, follow-time gap (F) 314, and time to overtake (O) 316.

Furthermore, a clearance time (C) is calculated as an amount of time between the vehicle 100 and the oncoming vehicle 308 while the vehicle 100 is in the second lane 304 executing the passing maneuver. In accordance with an exemplary embodiments, the clearance time represents an amount of time until the oncoming vehicle 308 would contact the vehicle 100 if these two vehicles were to continue along their respective paths (and with their respective velocities and accelerations) in the same lane (i.e., the second lane 304).

In various embodiments, as part of step 224, the clearance time (C) is calculated in accordance with the following equation:

$$( C ) = ( T T T ) - ( O ) - ( F ) - ( L ) , \qquad ( Equation 1 )$$

in which (C) represents the clearance time, (L) represents the time to lane change 312, (F) represents the follow-time gap 314, (O) represents the time to overtake 316, and (TTT) represents the time to target 310 as described above in connection with FIG. 3.

In various embodiments, during step 224, if it is determined that the clearance time is greater than or equal to a first threshold, then the passing maneuver is categorized into a first (e.g., low) risk level, associated with step 226 of FIG. 2 (and with associated displays being provided and actions being taken corresponding thereto, as described above in connection with FIG. 2).

Conversely, in various embodiments, also during step 224, if it is instead determined that the clearance time is less than or equal to the first threshold as well as less than or equal to a second threshold (wherein the second threshold is less than the first threshold), then the passing maneuver is categorized instead into a second (e.g., high) risk level, associated with step 216 of FIG. 2 (and with associated displays being provided and actions being taken corresponding thereto, as described above in connection with FIG. 2).

Furthermore, in various embodiments, also during step 224, if it is instead determined that the clearance time is less than or equal to the first threshold but greater than the second threshold, then the passing maneuver is categorized instead into a third (e.g., medium) risk level, associated with step 229 of FIG. 2 (and with associated displays being provided and actions being taken corresponding thereto, as described above in connection with FIG. 2).

In various embodiments, the above-referenced first, second, and third thresholds are stored in the memory 144 of FIG. 1 as stored values 154 therein. In various embodiments, the threshold may depend on the driver and/or the driving behavior of the driver, among other possible variations.

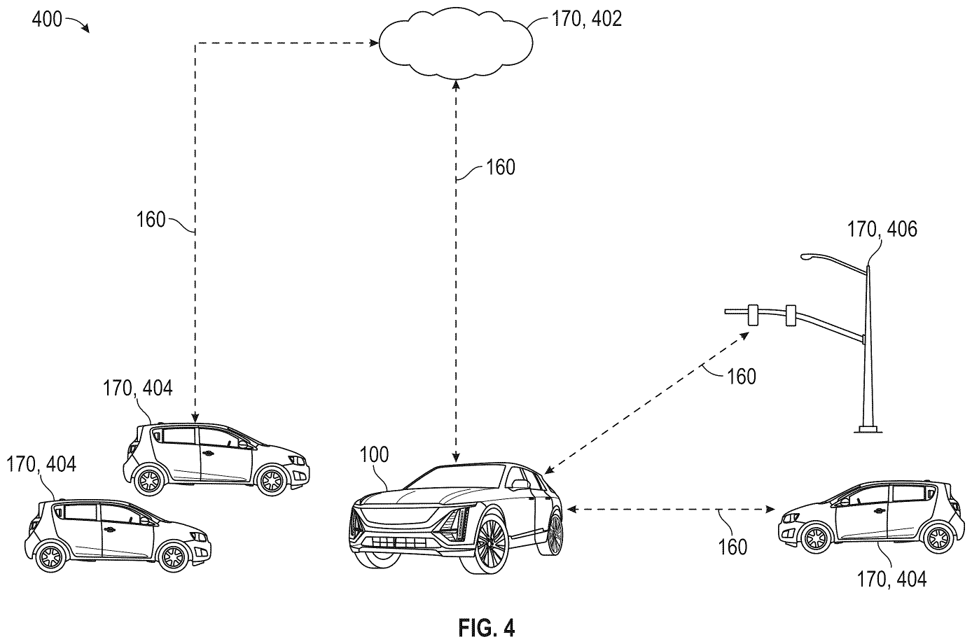

FIG. 4 provides an exemplary illustration 400 depicting an exemplary implementation of real-time connectivity for the process 200 of FIG. 2, including the step 224 thereof and depicted in FIG. 3, in accordance with exemplary embodiments. As depicted in FIG. 4, in an exemplary embodiment, the vehicle 100 is connected via one or more wireless communication networks 160 to one or more remote servers 402 in the cloud, as well as to one or more other vehicles 404 and one or more infrastructure 406 (e.g., a traffic light, sign, roadway apparatus, and/or other infrastructure). In various embodiments, the vehicle 100 communicates with the other vehicles 404 via vehicle-to-vehicle (V2V) communications, and communicates with the infrastructure via vehicle-to-infrastructure (V2X) communications, and so on.

In various embodiments, each of the remote server 402, other vehicles 404, and infrastructure 406 may correspond to and/or include and/or be coupled to one or more remote devices 170 of FIG. 1. Also in various embodiments, each of the remote server 402, other vehicles 404, and infrastructure 406 may provide data (such as sensor data, location data, map data, and so on) as to the roadway on which the vehicle 100 is travelling and other vehicles travelling along the roadway (e.g., in the same lane as the vehicle 100 as well as in lanes that are adjacent to the vehicle 100).

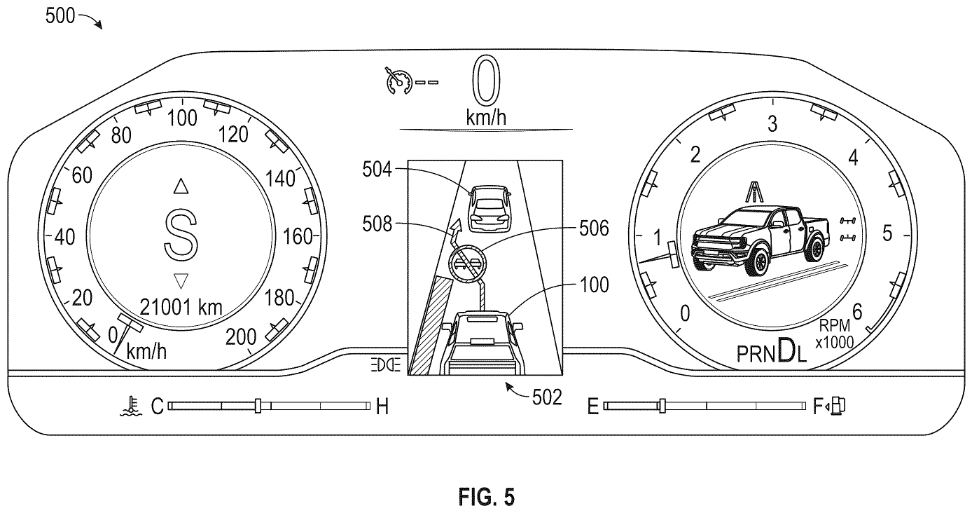

FIGS. 5-8 depict exemplary implementations of displays provided via the process 200 of FIG. 2, in accordance with exemplary embodiments. In various embodiments, the displays of FIGS. 5-8 each correspond to one of step 216 (e.g., a display with high caution), step 229 (e.g., a display with medium caution), or step 226 (e.g., a display with low caution). In certain embodiments, each of the displays are provided on a front dash of the vehicle 100 and/or elsewhere in a location that is visible to the driver (e.g., on a navigation screen in certain embodiments, or the like).

With reference first to FIG. 5, a first display 500 is provided in accordance with an exemplary embodiment. As depicted in FIG. 5, the first display 500 includes general information regarding vehicle speed, transmission gear, engine torque, and the like, as well as a driver assistance display 502 pertaining to a possible passing maneuver to overtake a slower moving vehicle that is ahead of and in the same lane as the vehicle 100.

In the example of FIG. 5, the driver assistance display 502 provides a depiction of the slow moving vehicle 504, in addition to an indication of the advisability 506 of the passing maneuver and a route 508 that would be taken if the passing maneuver were to be executed. In this particular example of FIG. 5, the indication of the advisability 506 shows that it would not be advisable to execute the passing maneuver (e.g., as represented by the circle with the slash mark through it). Also in this particular example, the indication of the advisability 506 also shows why it would not be advisable to execute the passing maneuver (e.g., as represented by the depiction of the oncoming vehicle). Also in an exemplary embodiment, the driver assistance display 502 is depicted in a first color (e.g., red) indicating that a high level of caution should be associated with the potential passing maneuver (e.g., corresponding to step 216 of FIG. 2).

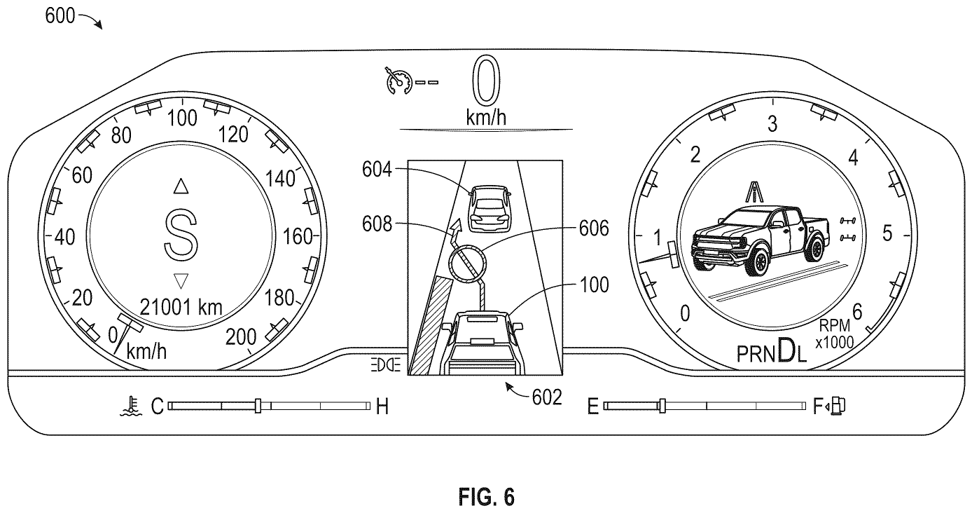

With reference next to FIG. 6, a second display 600 is provided in accordance with an exemplary embodiment. As depicted in FIG. 6, the second display 600 similarly includes general information regarding vehicle speed, transmission gear, engine torque, and the like, as well as a driver assistance display 602 pertaining to a possible passing maneuver to overtake a slower moving vehicle that is ahead of and in the same lane as the vehicle 100.

In the example of FIG. 6, the driver assistance display 602 provides a depiction of the slow moving vehicle 604, in addition to an indication of the advisability 606 of the passing maneuver and a route 608 that would be taken if the passing maneuver were to be executed. In this particular example of FIG. 6, the indication of the advisability 606 shows that it would not be advisable to execute the passing maneuver (e.g., as represented by the circle with the slash mark through it). Also in this particular example, the indication of the advisability 606 also shows why it would not be advisable to execute the passing maneuver (e.g., as represented by a statement that a passing lane will be available in two miles). Also in an exemplary embodiment, the driver assistance display 602 is depicted in the first color (e.g., red) indicating that a high level of caution should be associated with the potential passing maneuver (e.g., corresponding to step 216 of FIG. 2).

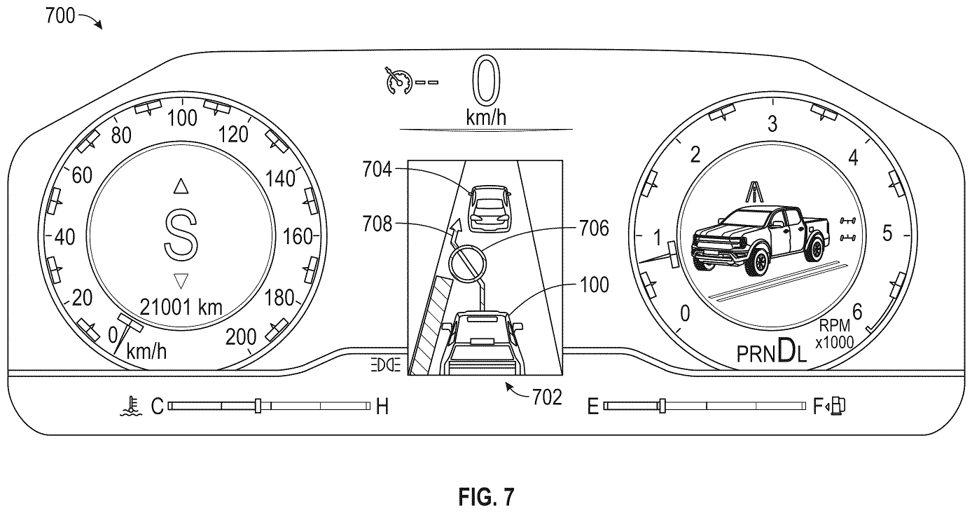

With reference to FIG. 7, a third display 700 is provided in accordance with an exemplary embodiment. As depicted in FIG. 7, the third display 700 similarly includes general information regarding vehicle speed, transmission gear, engine torque, and the like, as well as a driver assistance display 702 pertaining to a possible passing maneuver to overtake a slower moving vehicle that is ahead of and in the same lane as the vehicle 100.

In the example of FIG. 7, the driver assistance display 702 provides a depiction of the slow moving vehicle 704, in addition to an indication of the advisability 706 of the passing maneuver and a route 708 that would be taken if the passing maneuver were to be executed. In this particular example of FIG. 7, the indication of the advisability 706 shows that it may not be advisable to execute the passing maneuver (e.g., as there is a circle with a slash mark through it). Also in this particular example, the indication of the advisability 706 also shows why it may not be advisable to execute the passing maneuver (e.g., as represented by the depiction of the oncoming vehicle). Also in an exemplary embodiment, the driver assistance display 702 is depicted in a second color (e.g., yellow) indicating that a medium level of caution should be associated with the potential passing maneuver (e.g., corresponding to step 229 of FIG. 2)

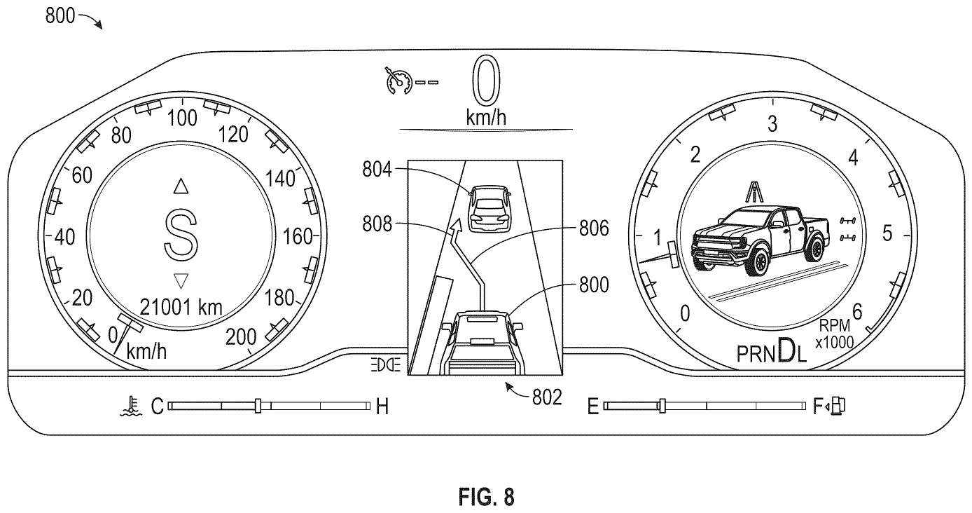

With reference to FIG. 8, a fourth display 800 is provided in accordance with an exemplary embodiment. As depicted in FIG. 8, the fourth display 800 similarly includes general information regarding vehicle speed, transmission gear, engine torque, and the like, as well as a driver assistance display 802 pertaining to a possible passing maneuver to overtake a slower moving vehicle that is ahead of and in the same lane as the vehicle 100.

In the example of FIG. 8, the driver assistance display 802 provides a depiction of the slow moving vehicle 804, in addition to an indication of the advisability 806 of the passing maneuver and a route 808 that would be taken if the passing maneuver were to be executed. In this particular example of FIG. 8, the indication of the advisability 806 shows that it is allowable to execute the passing maneuver (e.g., as there is no circle with a slash mark through it as with the other examples discussed above). Also in an exemplary embodiment, the driver assistance display 802 is depicted in a third color (e.g., green) indicating that a low level of caution should be associated with the potential passing maneuver e.g., corresponding to step 226 of FIG. 2).

Accordingly, methods, systems, and vehicles are provided for providing passing assistance for vehicles, including in a single lane of traffic. As described herein, in various embodiments, different levels of caution are provided with a proposed passing maneuver along a single lane of travel, based on various parameters that include a minimum overtake gap to pass a slower moving vehicle in the same lane, a required space after overtake of the slower moving vehicle, a time to lane change, follow-time gap, a time to overtake the slower moving vehicle, and a clearance time with respect to oncoming traffic in an adjacent lane, as depicted in the Figures and described above in connection various embodiments.

It will be appreciated that the systems, vehicles, and methods may vary from those depicted in the Figures and described herein. For example, the system 10, including the remote device 170, the vehicle 100 of FIG. 1 and the control system 102 thereof, and/or other components thereof may differ from that depicted in FIG. 1. It will similarly be appreciated that the steps of the processes and implementations of FIGS. 2-8 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining sensor data via one or more sensors of a vehicle that is travelling in a lane along a single lane roadway having a single lane in each direction, as to a second vehicle that is travelling in the same lane as the vehicle with a lower rate of speed as compared with the vehicle;
obtaining additional data as to the roadway, including oncoming traffic in an adjacent lane that is adjacent to the lane of the vehicle;
determining, via a processor of the vehicle using the sensor data and the additional data:
a passing maneuver for the vehicle to overtake the second vehicle; and
a level of caution associated with the passing maneuver; and
performing a vehicle control action, via instructions provided by the processor, based on the passing maneuver and the level of caution associated therewith.

2. The method of claim 1, wherein the additional data is further obtained from vehicle to vehicle communications and also includes map data as to features of the roadway, including whether a passing lane is present along the roadway in proximity to the vehicle, in addition to the oncoming traffic.

3. The method of claim 1, wherein the additional data is further obtained from vehicle to infrastructure communications and also includes map data as to features of the roadway, including whether a passing lane is present along the roadway in proximity to the vehicle, in addition to the oncoming traffic.

4. The method of claim 1, wherein the performing of the vehicle control action comprises providing a visual notification to a driver of the vehicle, on a display screen of the vehicle in accordance with instructions provided by the processor, with the level of caution, along with an indication as to whether or not it would be advisable to proceed with the passing maneuver.

5. The method of claim 4, wherein the performing of the vehicle control action further comprises controlling movement of the vehicle, in accordance with instructions provided by the processor and that are executed by one or more of a braking system, a steering system, and a drive system of the vehicle.

6. The method of claim 1, wherein the level of caution is determined via the processor based on a relative distance between the vehicle and the second vehicle, a relative distance between the vehicle and an oncoming vehicle of the oncoming traffic, and velocities and accelerations of each of the vehicle, the second vehicle, and the oncoming vehicle.

7. The method of claim 6, wherein the level of caution is determined via the processor based also on whether a passing lane is present along the roadway.

8. The method of claim 1, wherein the level of caution is determined via the processor in accordance with the following equation:
$$( C ) = ( T T T ) - ( O ) - ( F ) - ( L ) ,$$
in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic.

9. The method of claim 8, wherein:
if it is determined that the clearance time is greater than or equal to a first threshold, then the passing maneuver is categorized into a low risk level;
if it is instead determined that the clearance time is less than or equal to the first threshold as well as less than or equal to a second threshold that is less than the first threshold, then the passing maneuver is categorized instead into a high risk level; and
if it is instead determined that the clearance time is less than or equal to the first threshold but greater than the second threshold, then the passing maneuver is categorized instead into a medium risk level.

10. A system comprising:
one or more sensors of a vehicle that are configured to obtain, as the vehicle is travelling in a lane along a single lane roadway having a single lane in each direction, sensor data as to a second vehicle that is travelling in the same lane as the vehicle with a lower rate of speed as compared with the vehicle; and
a processor that is coupled to the one or more sensors and to one or more remote devices, and that is configured to at least facilitate:
receiving the sensor data from the one or more sensors;
receiving additional data from the one or more remote devices as to the roadway, including oncoming traffic in an adjacent lane that is adjacent to the lane of the vehicle; determining, using the sensor data and the additional data:
a passing maneuver for the vehicle to overtake the second vehicle; and
a level of caution associated with the passing maneuver; and
performing a vehicle control action, via instructions provided by the processor, based on the passing maneuver and the level of caution associated therewith.

11. The system of claim 10, wherein the additional data is further obtained from vehicle to vehicle communications and also includes map data as to features of the roadway, including whether a passing lane is present along the roadway in proximity to the vehicle, in addition to the oncoming traffic.

12. The system of claim 10, wherein the additional data is further obtained from vehicle to infrastructure communications and also includes map data as to features of the roadway, including whether a passing lane is present along the roadway in proximity to the vehicle, in addition to the oncoming traffic.

13. The system of claim 10, wherein the processor is further configured to at least facilitate performing the vehicle control action by providing a visual notification to a driver of the vehicle, on a display screen of the vehicle in accordance with instructions provided by the processor, with the level of caution, along with an indication as to whether or not it would be advisable to proceed with the passing maneuver.

14. The system of claim 13, wherein the processor is further configured to at least facilitate performing the vehicle control action by providing a haptic notification to the driver of the vehicle.

15. The system of claim 13, wherein the processor is further configured to at least facilitate performing the vehicle control action by controlling movement of the vehicle, in accordance with instructions provided by the processor and that are executed by one or more of a braking system, a steering system, and a drive system of the vehicle.

16. The system of claim 10, wherein the processor is further configured to at least facilitate determining the level of caution based on a relative distance between the vehicle and the second vehicle, a relative distance between the vehicle and an oncoming vehicle of the oncoming traffic, and velocities and accelerations of each of the vehicle, the second vehicle, and the oncoming vehicle, and further based on whether a passing lane is present along the roadway.

17. The system of claim 10, wherein the processor is further configured to at least facilitate determining the level of caution in accordance with the following equation:
$$( C ) = ( T T T ) - ( O ) - ( F ) - ( L ) ,$$
in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic.

18. The system of claim 17, wherein the processor is further configured to at least facilitate categorizing the passing maneuver into:
a low risk level, if it is determined that the clearance time is greater than or equal to a first threshold;
a high risk level, if it is instead determined that the clearance time is less than or equal to the first threshold as well as less than or equal to a second threshold that is less than the first threshold; and
a medium risk level, if it is instead determined that the clearance time is less than or equal to the first threshold but greater than the second threshold.

19. A vehicle comprising:
a body;
a drive system configured to move the body;
a display system having a display screen;
one or more sensors that are configured to obtain, as the vehicle is travelling along a roadway in a lane of a single lane highway having a single lane in each direction, sensor data as to a second vehicle that is travelling in the same lane as the vehicle with a lower rate of speed as compared with the vehicle;
a transceiver configured to receive additional data from one or more remote devices as to the roadway via vehicle to vehicle communications, vehicle to infrastructure communications, or both, wherein the additional data comprises whether a passing lane is present along the roadway in proximity to the vehicle, in addition to oncoming traffic, as the vehicle is travelling along the single lane highway; and
a processor that is coupled to the one or more sensors and to the transceiver, and that is configured to at least facilitate, as the vehicle is travelling along the single lane highway:
determining, using the sensor data and the additional data:
a passing maneuver for the vehicle to overtake the second vehicle; and
a level of caution associated with the passing maneuver determining the level of caution in accordance with the following equation:
$$( C ) = ( T T T ) - ( O ) - ( F ) - ( L ) ,$$
in which (CC) represents a clearance time between the vehicle and an oncoming vehicle of the oncoming traffic, (L) represents a time to lane change, represents a follow-time gap with respect to the second vehicle, (O) represents a time to overtake the second vehicle, and (TTT) represents a time to target with respect to the oncoming vehicle of the oncoming traffic, and including by categorizing the passing maneuver into:
a low risk level, if it is determined that the clearance time is greater than or equal to a first threshold;
a high risk level, if it is instead determined that the clearance time is less than or equal to the first threshold as well as less than or equal to a second threshold that is less than the first threshold; and
a medium risk level, if it is instead determined that the clearance time is less than or equal to the first threshold but greater than the second threshold; and
performing a vehicle control action, via instructions provided by the processor, based on the passing maneuver and the level of caution associated therewith, including by providing a visual notification to a driver of the vehicle, on the display screen of the vehicle in accordance with instructions provided by the processor, with the level of caution, along with an indication as to whether or not it would be advisable to proceed with the passing maneuver.

20. The vehicle of claim 19, further comprising:
a braking system; and
a steering system;
wherein the processor is further configured to at least facilitate performing the vehicle control action by controlling movement of the vehicle, in accordance with instructions provided by the processor and that are executed by one or more of the braking system, the steering system, and the drive system of the vehicle.
